(19) United States
(12) Patent Application Publication
(10) Pub. No.: US 2015/0149569 A1
(43) Pub. Date: May 28, 2015

(54) PUBLISH AND SUBSCRIBE BROKER WITH MULTIPLE ORTHOGONAL TOPIC TREES

(71) Applicant: INTERNATIONAL BUSINESS MACHINES CORPORATION, Armonk, NY (US)

(72) Inventors: Andrew S. Feltham, Chandlers Ford (GB); Dominic P. Harries, Winchester (GB); Graham White, Alton (GB)

(21) Appl. No.: 14/519,304

(22) Filed: Oct. 21, 2014

(30) Foreign Application Priority Data
Nov. 22, 2013 (GB) 1320621.4

(51) Int. Cl. H04L 12/58

(52) U.S. Cl. CPC H04L 51/02
USPC 709/206

(57) ABSTRACT

A publish subscribe broker system comprises a hardware receiver, one or more processors, and a hardware transmitter. The hardware receiver receives a message and two or more orthogonal message topics, wherein a topic is a branch of a topic tree. The one or more processors execute a subscription engine for identifying all subscribers whose subscription topics match the received two or more orthogonal message topics. The hardware transmitter sends the message only to identified subscribers and not to subscribers having just one of the orthogonal message topics.

### BACKGROUND

This invention relates to a method and apparatus for a publish and subscribe broker with multiple orthogonal topic trees.

A known publish and subscribe broker manages the dissemination of data from publisher to subscribers using a topic tree. Data will be published to a leaf of the tree, for example, “Sensors/UK” and then subscribers can subscribe to either an individual topic, or multiple topics using a wildcard subscription, or for example “Sensors/#”. This works well for many simple applications, but becomes more complicated when a topic tree is overloaded with multiple different ways of categorizing topics.

For example, multiple different types of sensor might publish to different topics such as: “Sensors/UK/temperature” or perhaps: “Sensors/location/UK/sensorType/temperature”. By overloading the topic tree in this way, it is still possible for a subscriber to subscribe to all UK sensors (“Sensors/UK/+” or “Sensors/location/UK/sensorType/+”) and to all temperature sensors (“Sensors/+/temperature” or “Sensors/location/+/sensorType/temperature”), but there are two shortcomings of this approach. 1) The topic names can quickly get unwieldy if there are many different categorizations in them. 2) All the flexibility of using a tree is lost, for example, if further categorization of sensors location to “/Sensors/UK/Winchester” is desired.

The plus (+) in “Sensors/UK/+” is a wildcard token that can represents any subtopic at a particular level in a topic tree. The hash (#) in “Sensors/UK/#” is a wildcard token that represents all subtopics at a particular level in a topic tree such that “Sensor/+/+” is equivalent to “Sensor/#”.

### SUMMARY

In one embodiment of the present invention, a publish subscribe broker system comprises: a hardware receiver for receiving a message and two or more orthogonal message topics, wherein a topic is a branch of a topic tree; a subscription engine for identifying all subscribers whose subscription topics match the two or more orthogonal message topics; and a hardware transmitter for sending the message only to identified subscribers and not to subscribers having just one of the orthogonal message topics.

In one embodiment of the present invention, a method and/or computer program product brokers a publish subscribe process. A hardware receiver receives a message and two or more orthogonal message topics, wherein a topic is a branch of a topic tree. One or more processors identify all subscribers whose subscription topics match the received two or more orthogonal message topics. A hardware transmitter sends the message to only the identified subscribers and not to subscribers having just one of the orthogonal message topics.

### BRIEF DESCRIPTION OF THE SEVERAL VIEWS OF THE DRAWINGS

Preferred embodiments of the present invention will now be described, by way of example only, with reference to the following drawings in which:

FIG. 1 is a deployment diagram of the preferred embodiment;

FIG. 2 is a component diagram of the preferred embodiment; and

FIG. 3 is a flow diagram of a process of the preferred embodiment.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

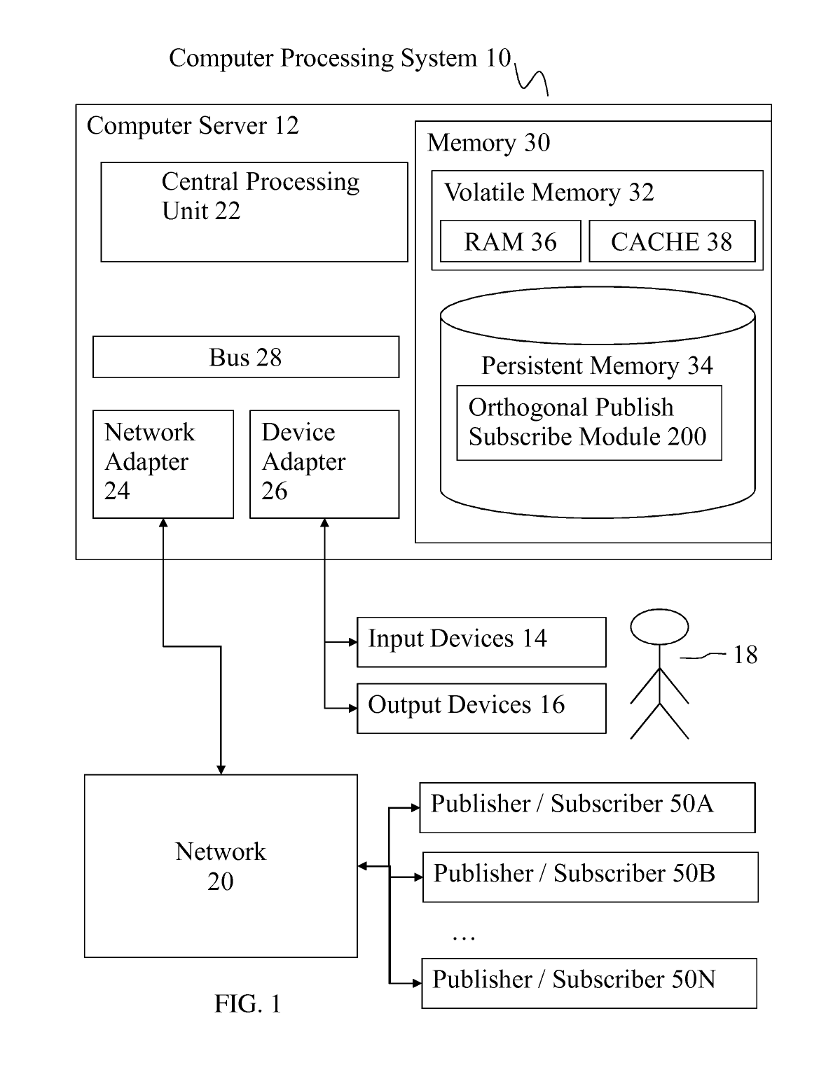

Referring to FIG. 1, the deployment of a preferred embodiment in computer processing system 10 is described. Computer processing system 10 is operational with numerous other general purpose or special purpose computing system environments or configurations. Examples of well-known computing processing systems, environments, and/or configurations that may be suitable for use with computer processing system 10 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer processing system 10 may be described in the general context of computer system-executable instructions, such as program modules, being executed by a computer processor. Generally, program modules may include routines, programs, objects, components, logic, and data structures that perform particular tasks or implement particular abstract data types. Computer processing system 10 may be embodied in distributed cloud computing environments where tasks are performed by remote processing devices that are linked through a communications network. In a distributed cloud computing environment, program modules may be located in both local and remote computer system storage media including memory storage devices.

Computer processing system 10 comprises: general-purpose computer server 12 and one or more input devices 14 and output devices 16 directly attached to the computer server 12. Computer processing system 10 communicates with a user 18 using input devices 14 and output devices 16. Input devices 14 include one or more of: a keyboard, a scanner, a mouse, trackball or another pointing device. Output devices 16 include one or more of a display or a printer. Computer processing system 10 communicates with network devices (not shown) over network 20. Network 20 can be a local area network (LAN), a wide area network (WAN), or the Internet. Computer processing system 10 is connected to a network 20. Connected to network 20 are a plurality of publish and subscribe nodes 50A, 50B to 50N. Each node 50A to 50N is adapted to communicate with computer server 12.

Computer server 12 comprises: central processing unit (CPU) 22; network adapter 24; device adapter 26; bus 28 and memory 30.

CPU 22 loads machine instructions from memory 30 and performs machine operations in response to the instructions. Such machine operations include: incrementing or decrementing a value in register (not shown); transferring a value from memory 30 to a register or vice versa; branching to a different location in memory if a condition is true or false (also known as a conditional branch instruction); and adding or subtracting the values in two different registers and loading the result in another register. A typical CPU can perform many different machine operations. A set of machine instructions is called a machine code program, the machine instructions are written in a machine code language which is referred to a low level language. A computer program written in a high level language needs to be compiled to a machine code program before it can be run. Alternatively a machine code program such as a virtual machine or an interpreter can interpret a high level language in terms of machine operations.

Network adapter 24 is connected to bus 28 and network 20 for enabling communication between the computer server 12 and network devices.

Device adapter 26 is connected to bus 28 and input devices 14 and output devices 16 for enabling communication between computer server 12 and input devices 14 and output devices 16.

Bus 28 couples the main system components together including memory 30 to CPU 22. Bus 28 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Memory 30 includes computer system readable media in the form of volatile memory 32 and non-volatile or persistent memory 34. Examples of volatile memory 32 are random access memory (RAM) 36 and cache memory 38. Generally volatile memory is used because it is faster and generally non-volatile memory is used because it will hold the data for longer. Computer processing system 10 may further include other removable and/or non-removable, volatile and/or non-volatile computer system storage media. By way of example only, persistent memory 34 can be provided for reading from and writing to a non-removable, non-volatile magnetic media (not shown and typically a magnetic hard disk or solid-state drive). Although not shown, further storage media may be provided including: an external port for removable, non-volatile solid-state memory; and an optical disk drive for reading from or writing to a removable, non-volatile optical disk such as a compact disk (CD), digital video disk (DVD) or Blu-ray. In such instances, each can be connected to bus 28 by one or more data media interfaces. As will be further depicted and described below, memory 30 may include at least one program product having a set (for example, at least one) of program modules that are configured to carry out the functions of embodiments of the invention.

The program module configured to carry out the functions of the preferred embodiment comprises orthogonal publish subscribe module 200. Further program modules that support the preferred embodiment but are not shown include firmware, boot strap program, operating system, and support applications. Each of the operating system, support applications, other program modules, and program data or some combination thereof, may include an implementation of a networking environment.

Computer processing system 10 communicates with at least one network 20 (such as a local area network (LAN), a general wide area network (WAN), and/or a public network like the Internet) via network adapter 24. Network adapter 24 communicates with the other components of computer server 12 via bus 28. It should be understood that although not shown, other hardware and/or software components could be used in conjunction with computer processing system 10. Examples, include, but are not limited to: microcode, device drivers, redundant processing units, external disk drive arrays, redundant array of independent disks (RAID), tape drives, and data archival storage systems.

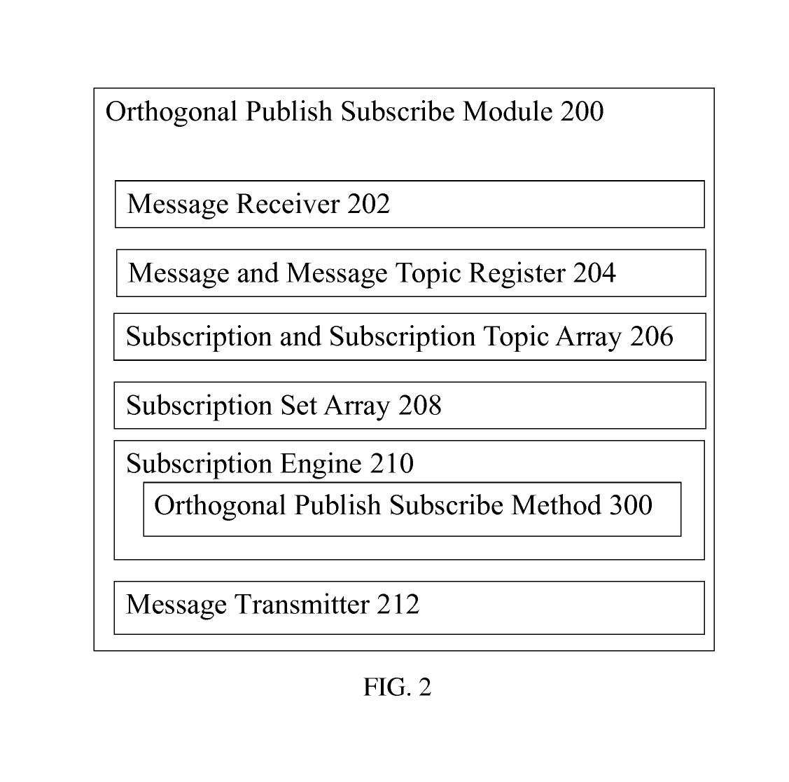

Referring to FIG. 2, orthogonal publish subscribe module 200 comprises the following components: a message receiver 202; a message and message topic register 204; a subscription and subscription topic array 206; a subscription set array 208; a subscription engine 210; and a message transmitter 212.

Message receiver 202 is for receiving messages.

Message and message topic register 204 is for storing the received message and message topics.

Subscription and subscription topic array 206 is for storing the subscribers and associated topics.

Subscription set array 208 is for storing identified subscribers.

Subscription engine 210 comprises orthogonal publish subscribe method 300 described in more detail below.

Message transmitter 212 is for transmitting the messages to the identified subscribers.

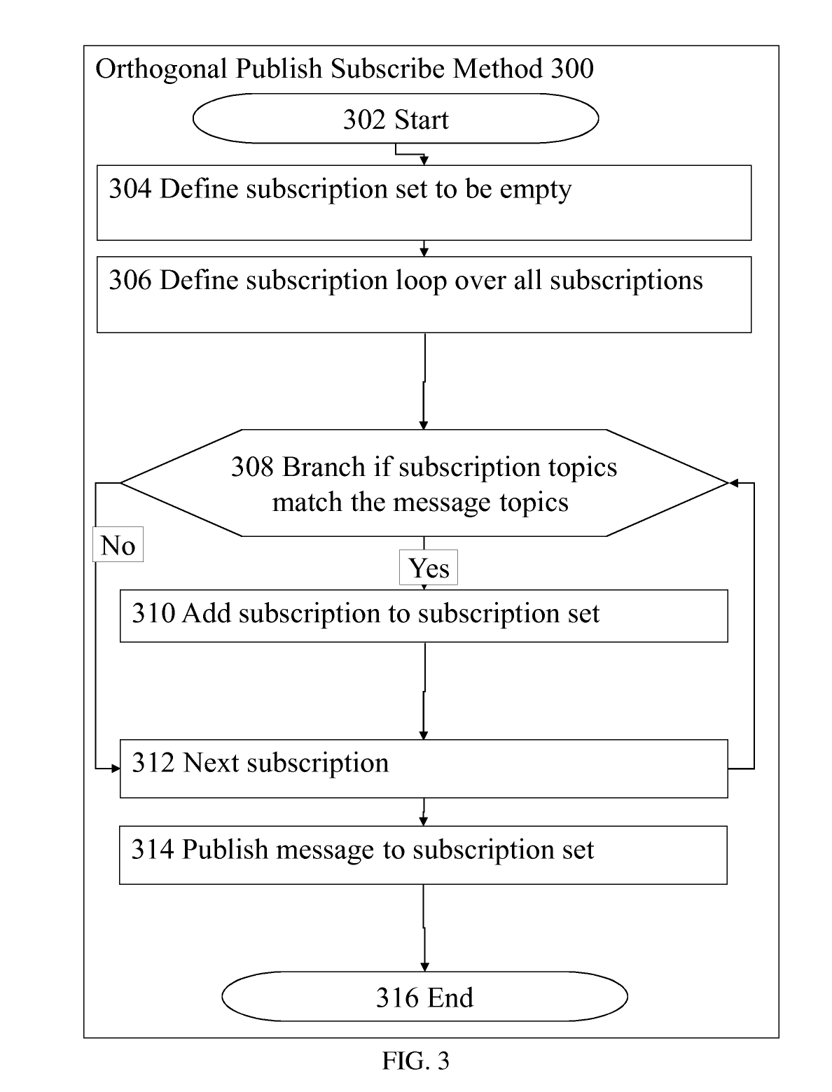

Referring to FIG. 3, orthogonal publish subscribe method 300 comprises logical process steps 302 to 316.

Step 302 is the start of the method when a message and message topics are received by the system. A message has a topics array associated with it, as do each of the subscriptions. The received message topics are the message topic set. The subscription string can contain one or more wildcard tokens.

Step 304 is for defining a subscription set to hold identified subscriptions. The subscription set is stored in the subscription set array 206.

Step 306 is for defining a subscription loop over all subscriptions.

Step 308 is for branching to step 310 if the subscription topic set matches the message topic set. Else step 312.

Step 310 is for adding a matched subscription to the subscription set.

Step 312 is for looping to step 308 with the next subscription if there is one.

Step 314 is for publishing the message to subscription set.

Step 316 is the end of orthogonal publish subscribe method 300.

The above schematic embodiment uses a fixed vector of topic trees requiring a fixed order of topics.

For example, a temperature sensor in a lab might publish a message as follows:

PUBLISH [“location/UK/Winchester”, “sensorType/temperature”]

PAYLOAD: “21 degrees”

This is not a publish to two separate topics but a publish to an intersection of two topic branches on two separate topic trees.

A subscriber could issue a subscription as follows:

SUBSCRIBE [“location/UK/Winchester”, “sensorType/temperature”]

Or to subscribe to all temperature sensors, regardless of location:

SUBSCRIBE [“#”, “sensorType/temperature”]

Similar to the publish example, these subscribe calls do not contain separate subscriptions, rather the client is subscribing to the intersection of two distinct topic trees.

Another embodiment is envisaged that uses named topic trees. With named topic trees, publishers and subscribers need not specify (or even know about) all the different topic trees that exist on the broker. For example, a publisher might publish as follows:

PUBLISH [Location=“location/UK/Winchester”]

PAYLOAD: “21 degrees”

This would be interpreted as:

PUBLISH [Location=“location/UK/Winchester”, SensorType=null]

PAYLOAD: “21 degrees”

Likewise subscribers would only need to specify the topic tree that they were interested in:

SUBSCRIBE [Location=“location/UK/Winchester”]

Depending on the chosen implementation, a subscription call like this could be interpreted in two ways, either:

SUBSCRIBE [Location=“location/UK/Winchester”, SensorType=“#”]

Or

SUBSCRIBE [Location=“location/UK/Winchester”, SensorType=null]

Note that the first of these would match all subscriptions regardless of their sensor type topic; the second would match only messages that were published without a specified sensor type topic. Throughout the description, for consistency, the location and prefixes have been shown in the topic names but in practice these are redundant and could be removed.

Further embodiments of the invention are now described. It will be clear to one of ordinary skill in the art that all or part of the logical process steps of the preferred embodiment may be alternatively embodied in a logic apparatus, or a plurality of logic apparatus, comprising logic elements arranged to perform the logical process steps of the method and that such logic elements may comprise hardware components, firmware components or a combination thereof.

It will be equally clear to one of skill in the art that all or part of the logic components of the preferred embodiment may be alternatively embodied in logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In a further alternative embodiment, the present invention may be realized in the form of a computer implemented method of deploying a service comprising steps of deploying computer program code operable to, when deployed into a computer infrastructure and executed thereon, cause the computer system to perform all the steps of the method.

It will be appreciated that the method and components of the preferred embodiment may alternatively be embodied fully or partially in a parallel computing system comprising two or more processors for executing parallel software.

In a first aspect of the invention there is provided a publish subscribe broker comprising: a receiver for receiving a message and two or more orthogonal message topics wherein a topic is a branch of a topic tree; a subscription engine for identifying all subscribers whose subscription topics match the two or more associated message topics; and a message transmitter for sending the message to identified subscribers and not to subscribers having just one of the associated topics.

In a second aspect of the invention there is provided a method for a publish subscribe broker comprising: receiving a message and two or more orthogonal message topics, wherein a topic is a branch of a topic tree; identifying all subscribers whose subscription topics match the two or more received message topics; and sending the message to only the identified subscribers and not to subscribers having just one of the associated topics.

Advantageously a topic tree is a fixed vector of a topic.

More advantageously each topic tree has an order and received messages topics must use the topic tree order.

Still more advantageously a topic tree is a list of named topics. The order of the received message topics is not important and not all topics need to be specified.

Yet more advantageously topic trees can be a mixture of fixed vectors and a list of named topics.

Preferably a topic comprises a branch of a topic tree and a branch comprises a sequence of topic nodes.

Still more preferably a topic node can comprise a wildcard node for representing any topic node at the position of the wildcard node.

Yet more preferably a topic node can comprise an extended wildcard node for representing any combination of topic nodes at and after the position of the extended wildcard node.

The embodiments allow messages to be published to multiple orthogonal topics, and to allow subscribers in turn to subscribe to the intersection of these trees. This is not a publish to two separate topics but a publish to an intersection of two topic branches on two separate topic trees.

In a third aspect of the invention there is provided a computer program product for a publish subscribe broker, the computer program product comprising a computer-readable storage medium having computer-readable program code embodied therewith and the computer-readable program code configured to perform all the steps of the methods.

In a fourth aspect of the invention there is provided a computer program stored on a computer readable medium and loadable into the internal memory of a computer, comprising software code portions, when said program is run on a computer, for performing all the steps of the method claims.

In a fifth aspect of the invention there is provided a data carrier aspect of the preferred embodiment that comprises functional computer data structures to, when loaded into a computer system and operated upon thereby, enable said computer system to perform all the steps of the method claims. A suitable data-carrier could be a solid-state memory, magnetic drive or optical disk. Channels for the transmission of data may likewise comprise storage media of all descriptions as well as signal-carrying media, such as wired or wireless signal-carrying media.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A publish subscribe broker system comprising:
a hardware receiver for receiving a message and two or more orthogonal message topics, wherein a topic is a branch of a topic tree;
a subscription engine for identifying all subscribers whose subscription topics match the two or more orthogonal message topics; and
a hardware transmitter for sending the message only to identified subscribers and not to subscribers having just one of the orthogonal message topics.

2. The publish subscribe broker system as in claim 1, wherein the topic tree is a fixed vector of the topic.

3. The publish subscribe broker system as in claim 2, wherein the topic tree has a topic tree order, and wherein received messages topics must use the topic tree order.

4. The publish subscribe broker system as in claim 1, wherein the topic tree is a list of named topics.

5. The publish subscribe broker system as in claim 1, wherein the topic tree is a mixture of fixed vectors and a list of named topics.

6. The publish subscribe broker system as in claim 1, wherein the branch of the topic tree comprises a sequence of topic nodes.

7. The publish subscribe broker system as in claim 6, wherein the topic tree comprises a wildcard node for representing any topic node at a position of the wildcard node.

8. The publish subscribe broker system as in claim 6, wherein a topic tree comprises an extended wildcard node for representing any combination of topic nodes at and after a position of the extended wildcard node.

9. A method for brokering a publish subscribe process, the method comprising:
receiving, by a hardware receiver, a message and two or more orthogonal message topics, wherein a topic is a branch of a topic tree;
identifying, by one or more processors, all subscribers whose subscription topics match the received two or more orthogonal message topics; and
sending, by a hardware transmitter, the message to only identified subscribers and not to subscribers having just one of the orthogonal message topics.

10. The method as in claim 9, wherein the topic tree is a fixed vector of the topic.

11. The method as in claim 10, wherein the topic tree has a tropic tree order and received messages topics must use the topic tree order.

12. The method as in claim 9, wherein the topic tree is a list of named topics.

13. The method as in claim 9, wherein the topic tree is a mixture of fixed vectors and a list of named topics.

14. The method as in claim 9, wherein the branch of the topic tree comprises a sequence of topic nodes.

15. The method as in claim 14, wherein the topic tree comprises a wildcard node for representing any topic node at a position of the wildcard node.

16. The method as in claim 14, wherein the topic tree comprises an extended wildcard node for representing any combination of topic nodes at and after a position of the extended wildcard node.

17. A computer program product for brokering a publish subscribe process, the computer program product comprising a computer readable storage medium having program code embodied therewith, wherein the computer readable storage medium is not a transitory signal per se, and wherein the program code is readable and executable by a processor to perform a method comprising:
receiving, by a hardware receiver, a message and two or more orthogonal message topics, wherein a topic is a branch of a topic tree;
identifying all subscribers whose subscription topics match the received two or more orthogonal message topics; and
sending, by a hardware transmitter, the message to only the identified subscribers and not to subscribers having just one of the orthogonal message topics.

18. The computer program product of claim 17, wherein the topic tree is a fixed vector of the topic.

19. The computer program product of claim 18, wherein the topic tree has a topic tree order and received messages topics must use the topic tree order.

20. The computer program product of claim 17, wherein the topic tree is a list of named topics.
